(19) United States
(12) Patent Application Publication
(10) Pub. No.: US 2019/0185091 A1
(43) Pub. Date: Jun. 20, 2019

(54) MULTIFUNCTIONAL MOTORCYCLE PASSENGER SEAT SYSTEM

(71) Applicant: Dejan Mitrovic, Kelowna (CA)

(72) Inventor: Dejan Mitrovic, Kelowna (CA)

(21) Appl. No.: 15/843,658

(22) Filed: Dec. 15, 2017

(51) Int. Cl. B62J 1/28; B62K 19/46

(52) U.S. Cl. CPC B62J 1/28; B62K 19/46

(57) ABSTRACT

A multifunctional motorcycle passenger seat system includes a passenger-seat assembly including an upper-body and at least one mount. The passenger-seat assembly may be attached to a motorcycle and provide a passenger-seat assembly with extra storage for safely storing items.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of chairs and seats and more specifically relates to a multifunctional motorcycle passenger seat system.

### 2. Description of Related Art

A motorcycle often called a bike, motorbike, or cycle is a two-or three-wheeled motor vehicle. Motorcycle design varies greatly to suit a range of different purposes: long distance travel, commuting, cruising, sport including racing, and off-road riding. Motorcycling is riding a motorcycle and related social activity such as joining a motorcycle club and attending motorcycle rallies. A motorcycle saddle is a term for a motorcycle seat in some parts of the world. It is a seat for carrying a rider and, possibly, a passenger, and which is attached to a motorcycle often but not exclusively, behind the fuel tank. Motorcycles do not provide adequate storage space. A suitable solution is desired.

U.S. Pat. No. 7,556,114 to Michael W. Hanagan relates to a motorcycle with interchangeable rear components. The described motorcycle with interchangeable rear components includes a convertible motorcycle assembly has a chassis, a driver's seat, and a latch assembly which secures the driver's seat to the forward portion of the chassis. A bracket mounted on the chassis adjacent the rearward end of the driver's seat and selectively mounted on the chassis rearwardly of the driver's seat are interchangeable rear components comprising a passenger seat and a storage compartment. The forward end of the interchangeable rear components has at least one forwardly extending tongue engaged with the bracket, and the rear component is secured to the chassis by a second latch assembly adjacent the rear end of the rear component. This latch assembly includes a second releasable latch on the chassis and second key lock on the rear component engaged with the second latch assembly for effecting and preventing release of the second latch assembly.

### BRIEF SUMMARY OF THE INVENTION

In view of the foregoing disadvantages inherent in the known chairs and seats art, the present disclosure provides a novel multifunctional motorcycle passenger seat system. The general purpose of the present disclosure, which will be described subsequently in greater detail, is to provide a multifunctional seat having additional useful storage.

A preferred embodiment of the multifunctional motorcycle passenger seat system comprises: a passenger-seat assembly including a seat-body having a cover (optionally), a pad, and at least one mounting-tab, a storage container having an inner-volume, and an outer surface (suitable for storage). The multifunctional motorcycle passenger seat system comprises the passenger-seat assembly. The passenger-seat assembly comprises in functional and integral combination the seat-body and the storage container. In this embodiment, the seat-body comprises the cover to substantially envelope the pad; the pad suitable for sitting on, the at least one mounting-tab suitable for removably coupling the passenger-seat assembly to a motorcycle. The storage container is defined by the inner-volume, and the outer surface. The passenger-seat assembly is configured to be attached to a motorcycle via at least one mounting-tab to provide seating for a passenger and use of the inner-volume when desired for storage.

A multifunctional motorcycle passenger seat system is disclosed herein. The multifunctional motorcycle passenger seat system includes a passenger-seat assembly including an upper-body having a plurality of upper-magnets, and an inner-volume, and a lower-body having a plurality of ferrous magnetic plates, and at least one mount. The upper-body and the lower-body are removeably coupleable via mating of the plurality of upper-magnets and the plurality of ferrous magnetic plates. The inner-volume is occupied within confines of the upper-body. The passenger-seat assembly may be attached to a motorcycle and provide a passenger-seat assembly with extra storage for safely storing liquids and other items.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a multifunctional motorcycle passenger seat system, constructed and operative according to the teachings of the present disclosure.

FIG. 1 is a perspective view of the multifunctional motorcycle passenger seat system during an ‘in-use’ condition, according to an embodiment of the disclosure.

FIG. 2 is a perspective view of the multifunctional motorcycle passenger seat system of FIG. 1, according to an embodiment of the present disclosure.

FIG. 3 is a perspective view of the multifunctional motorcycle passenger seat system of FIG. 1, according to an embodiment of the present disclosure.

FIG. 4 is a perspective view of the multifunctional motorcycle passenger seat system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a chairs and seats and more particularly to a multifunctional motorcycle passenger seat system as used to improve the functionality of motorcycles during use.

Generally, the present invention provides additional storage space for motorcycles. A user my remove an original (existing) passenger seat and replace it with the new passenger seat. As designed the device provides a seat having multiple functions including extra storage, is water proof seat, impact safe, heat safe, and safe for storing potable liquids (no chemicals). The multifunctional motorcycle passenger seat system may be installed to a motorcycle without changing the look and functionality of the vehicle.

A preferred embodiment of the multifunctional motorcycle passenger seat system comprises: a passenger-seat assembly including a seat-body having a cover (optionally); a pad; and at least one mounting-tab; a storage container having an inner-volume; and an outer surface (suitable for storage). The multifunctional motorcycle passenger seat system comprises the passenger-seat assembly; wherein the passenger-seat assembly comprises in functional and integral combination the seat-body and the storage container. In this embodiment the seat-body comprises the cover to substantially envelope the pad; the pad suitable for sitting on, the at least one mounting-tab suitable for removably coupling the passenger-seat assembly to a motorcycle. The storage container is defined by the inner-volume, and the outer surface; wherein the passenger-seat assembly is configured to be attached to a motorcycle via the at least one mounting-tab to provide seating for a passenger and use of the inner-volume when desired for storage.

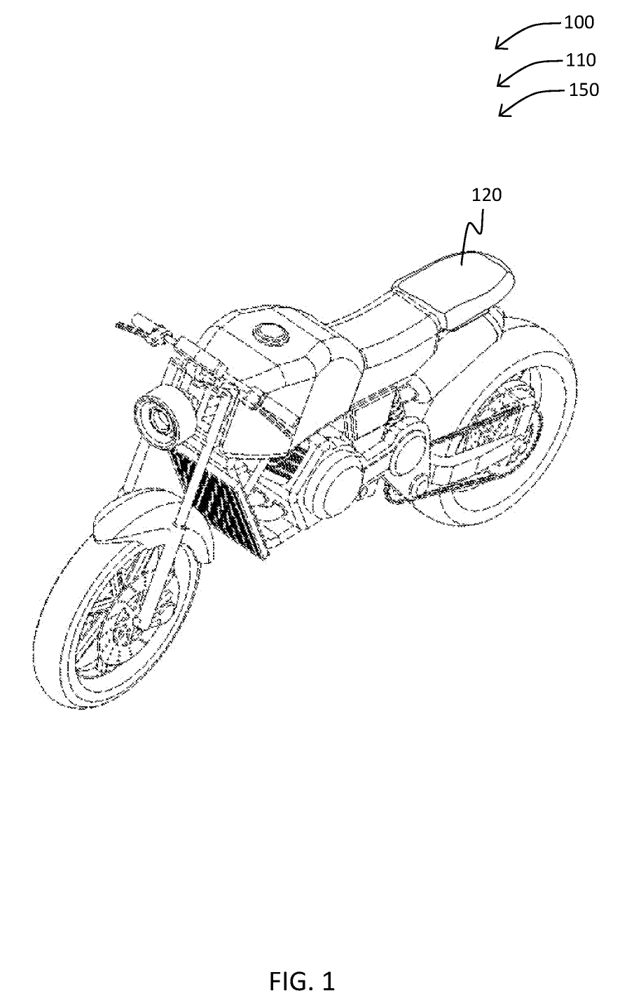

Referring now more specifically to the drawings by numerals of reference, there is shown in FIGS. 1-4, various views of a multifunctional motorcycle passenger seat system 100. FIG. 1 shows a multifunctional motorcycle passenger seat system 100 during an ‘in-use’ condition 150, according to an embodiment of the present disclosure. In certain embodiments the multifunctional motorcycle passenger seat system 100 may be integrally combined with inner-volume 124, as discussed above or in alternate embodiments may include a passenger-seat assembly 110 including an upper-body 120 and at least one mount 160. The inner-volume 124 is occupied within confines of the upper-body 120. The passenger-seat assembly 110 is configured to be attached to a motorcycle 10 via the at least one mount 160 to provide seating for a passenger and use of the inner-volume 124 when desired. Other means for fastening other than magnets may be used in alternate embodiments.

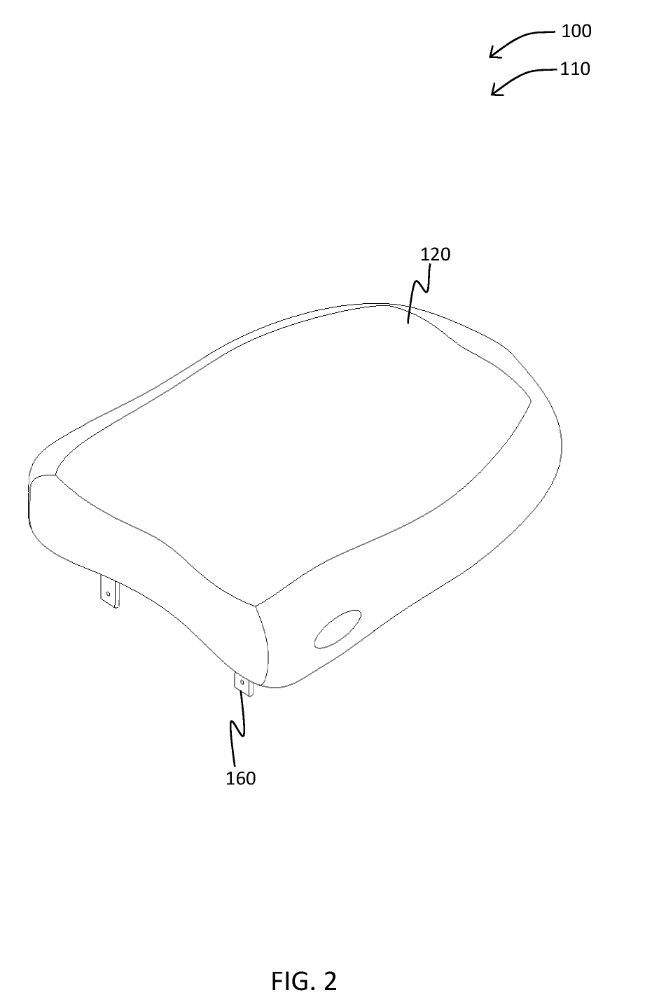

FIG. 2 shows a view of the multifunctional motorcycle passenger seat system 100 of FIG. 1, according to an embodiment of the present disclosure. As above, the multifunctional motorcycle passenger seat system 100 may include a passenger-seat assembly 110 an upper-body 120 and at least one mount 160. The passenger-seat 110 is a retro-fit to replace an existing-passenger-seat. Various sizes and mounting means are available for retro-fit to various host motorcycles. Certain embodiments may include magnets for further mounting additional items.

The inner-volume 124 is configured for storage of at least one item such as tools or other items and may house a hydration pack. The hydration pack may fit into an upper part of the inner-volume 124. The inner-volume 124 comprises a storage capacity of approximately 1.5 liters in preferred embodiments. The upper-body 120 and the lower-body 130 may be couplable via a waterproof connection with a silicone seal. A plastic housing of the upper-body 120 and the lower-body 130 may comprise semi-rigid urethane plastic. The present invention provides a passenger-seat assembly 110 with extra storage for safely storing liquids and other items.

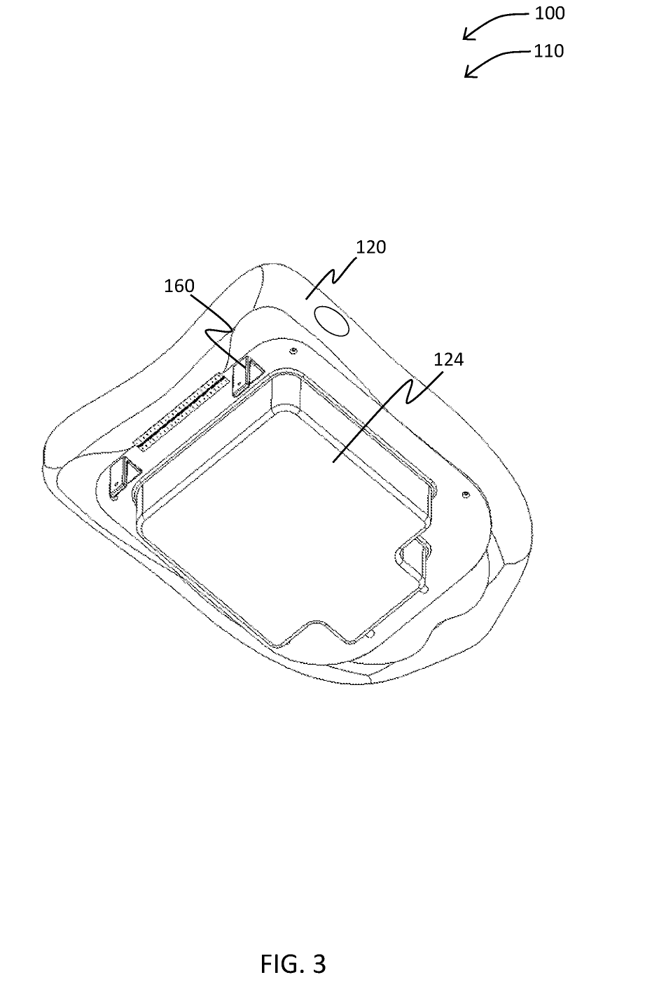

FIG. 3 shows a perspective view of the multifunctional motorcycle passenger seat system 100 of FIG. 1, according to an embodiment of the present disclosure. As above, the multifunctional motorcycle passenger seat system 100 may include a passenger-seat assembly 110 including an upper-body 120 and at least one mount 160. A user may remove an original passenger seat and replace it with the passenger-seat assembly 110 without changing the look and functionality of a motorcycle. The motorcycle may include a Honda CRF 1000 2016-2017 Model. The passenger-seat assembly 110 may include a plurality of layers including a leather cover and at least one foam layer.

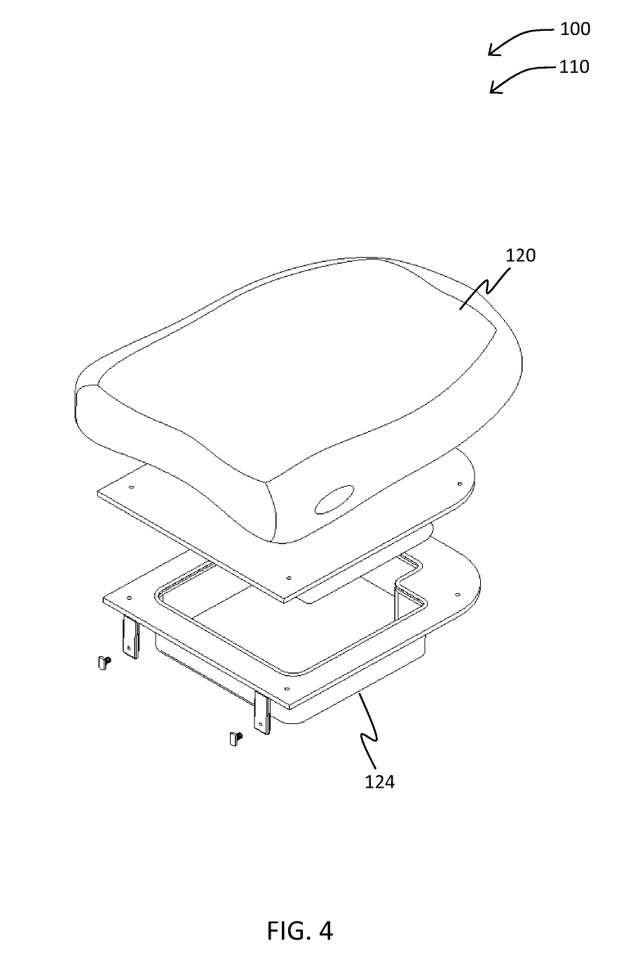

FIG. 4 shows a perspective view of the multifunctional motorcycle passenger seat system 100 of FIG. 1, according to an embodiment of the present disclosure. As above, the multifunctional motorcycle passenger seat system 100 may include a passenger-seat assembly 110 including the upper-body 120. The passenger-seat assembly 110 may be waterproof and resistant to heat-damage and impact-damage. In certain embodiments, the passenger-seat assembly 110 may further comprise a locking mechanism which secures and seals the upper-body 120 to a lower-body 130. The locking mechanism includes a handle which is able to be rotated to lock and un-lock the upper-body 120 from the lower-body. The locking mechanism may comprise a spring washer. The locking mechanism requires a 90 degree rotation to lock and unlock.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A multifunctional motorcycle passenger seat system comprising:
a passenger-seat assembly including;
an upper-body having;
a plurality of upper-magnets; and
an inner-volume; and
a lower-body having;
a plurality of ferrous magnetic plates; and
at least one mount;
wherein said upper-body and said lower-body are removeably coupleable via mating of said plurality of upper-magnets and said plurality of ferrous magnetic plates;
wherein said inner-volume is occupied within confines of said upper-body; and
wherein said passenger-seat assembly is configured to be attached to a motorcycle via said at least one mount to provide seating for a passenger and use of said inner-volume when desired.

2. The multifunctional motorcycle passenger seat system of claim 1, wherein said passenger-seat is a retro-fit to replace an existing-passenger-seat.

3. The multifunctional motorcycle passenger seat system of claim 1, wherein said inner-volume is configured for storage of at least one item.

4. The multifunctional motorcycle passenger seat system of claim 3, wherein said at least one item comprises a hydration pack.

5. The multifunctional motorcycle passenger seat system of claim 3, wherein said at least one item comprises at least one tool.

6. The multifunctional motorcycle passenger seat system of claim 1, wherein said upper-body and said lower-body are couplable via a waterproof connection with a silicone seal.

7. The multifunctional motorcycle passenger seat system of claim 1, wherein a plastic housing of said upper-body and said lower-body comprise semi-rigid urethane plastic.

8. The multifunctional motorcycle passenger seat system of claim 1, wherein said plurality of upper-magnets are positioned at opposing corners of said upper-body suitable for coupling to said plurality of ferrous magnetic plates located on opposing corners of said lower-body in a mated-relationship.

9. The multifunctional motorcycle passenger seat system of claim 1, wherein said passenger-seat assembly is waterproof.

10. The multifunctional motorcycle passenger seat system of claim 1, wherein said passenger-seat assembly further comprises a locking mechanism.

11. The multifunctional motorcycle passenger seat system of claim 10, wherein said locking mechanism secures and seals said upper-body to said lower-body.

12. The multifunctional motorcycle passenger seat system of claim 11, wherein said locking mechanism includes a handle which is able to be rotated to lock and un-lock said upper-body from said lower-body.

13. The multifunctional motorcycle passenger seat system of claim 12, wherein said locking mechanism comprises a spring washer.

14. The multifunctional motorcycle passenger seat system of claim 12, wherein said locking mechanism requires a 90 degree rotation to lock and unlock.

15. The multifunctional motorcycle passenger seat system of claim 1, wherein said upper-body and said lower-body are resistant to heat-damage.

16. The multifunctional motorcycle passenger seat system of claim 1, wherein said inner-volume comprises a storage capacity of approximately 1.5 liters.

17. A multifunctional motorcycle passenger seat system comprising:
a passenger-seat assembly including;
an upper-body having;
a plurality of upper-magnets; and
an inner-volume; and
a lower-body having;
a plurality of ferrous magnetic plates; and
at least one mount;
wherein said upper-body and said lower-body are removeably coupleable via mating of said plurality of upper-magnets and said plurality of ferrous magnetic plates;
wherein said inner-volume is occupied within confines of said upper-body;
wherein said inner-volume is configured for storage of at least one item;
wherein said inner-volume comprises a storage capacity of approximately 1.5 liters;
wherein said at least one item comprises a hydration pack;
wherein said passenger-seat assembly is configured to be attached to a motorcycle via said at least one mount to provide seating for a passenger and use of said inner-volume when desired;
wherein said passenger-seat is a retro-fit to replace an existing-passenger-seat;
wherein said passenger-seat assembly further comprises a locking mechanism;
wherein said locking mechanism secures and seals said upper-body to said lower-body;
wherein said locking mechanism includes a handle which is able to be rotated to lock and un-lock said upper-body from said lower-body;
wherein said locking mechanism comprises a spring washer;
wherein said locking mechanism requires a 90 degree rotation to lock and unlock;
wherein said upper-body and said lower-body are resistant to heat-damage;
wherein said upper-body and said lower-body are couplable via a waterproof connection with a silicone seal;
wherein a plastic housing of said upper-body and said lower-body comprise semi-rigid urethane plastic;
wherein said plurality of upper-magnets are positioned at opposing corners of said upper-body suitable for coupling to said plurality of ferrous magnetic plates located on opposing corners of said lower-body in a mated-relationship; and
wherein said passenger-seat assembly is waterproof.

18. A multifunctional motorcycle passenger seat system comprising:
a passenger-seat assembly including;
a seat-body having;
a cover;
a pad; and
at least one mounting-tab;
a storage container having
an inner-volume; and
an outer surface;
wherein said multifunctional motorcycle passenger seat system comprises said passenger-seat assembly;
wherein said passenger-seat assembly comprises in functional and integral combination said seat-body and said storage container;
wherein said seat-body comprises said cover to substantially envelope said pad, said pad suitable for sitting on, said at least one mounting-tab suitable for removably coupling said passenger-seat assembly to a motorcycle;
wherein said storage container is defined by said inner-volume, and said outer surface; and
wherein said passenger-seat assembly is configured to be attached to a motorcycle via said at least one mounting-tab to provide seating for a passenger and use of said inner-volume when desired for storage.
